(19) United States
(12) Patent Application Publication
(10) Pub. No.: US 2016/0026728 A1
(43) Pub. Date: Jan. 28, 2016

(54) Interaction Method And Device Between Browsers And Browser

(71) Applicant: TENCENT TECHNOLOGY (SHENZHEN) COMPANY LIMITED, Shenzhen City (CN)

(72) Inventors: Ai LI, Shenzhen (CN); Te QI, Shenzhen (CN); Ying DONG, Shenzhen (CN)

(21) Appl. No.: 14/872,200

(22) Filed: Oct. 1, 2015

Related U.S. Application Data
(63) Continuation of application No. PCT/CN2013/090196, filed on Dec. 23, 2013.

(30) Foreign Application Priority Data
Apr. 8, 2013 (CN) 201310118771.6

(51) Int. Cl. G06F 17/30; H04L 29/08

(52) U.S. Cl. CPC G06F 17/30887; H04L 67/02; G06F 17/30905

(57) ABSTRACT

An interaction method and device between browsers and a browser is described. The method includes receiving a unique Identification (ID), generating a Uniform Resource Locator (URL) with the unique ID, obtaining webpage operation data of a webpage corresponding to the URL stored by a browser according to the unique ID, and interacting with the browser with the webpage operation data.

### CROSS-REFERENCE TO RELATED APPLICATIONS

This application is a continuation of International Application No. PCT/CN2013/090196, filed Dec. 23, 2013. This application claims the benefit and priority of Chinese Application No. 201310118771.6, filed Apr. 8, 2013. The entire disclosures of each of the above applications are incorporated herein by reference.

### FIELD

The present disclosure relates to information processing technology and an interaction between browsers and a browser.

### BACKGROUND

This section provides background information related to the present disclosure which is not necessarily prior art.

With the development of computer technologies and network technologies, the Internet and Instant Messaging (IM) technologies have an increasingly prominent role in people's daily life, study, and work. Further, the Internet is increasingly mobile because of the development of the mobile Internet. In the information era, various information devices may be developed. The information devices may include a fixed-line telephone and a mobile phone for voice transmission, a server and a Personal Computer (PC) for sharing and processing information and resources, and various televisions for displaying video data, etc. These information devices may be applied to various fields for solving actual demands. With the fusion of Consumer electronics, Computer and Communication (3C), people may pay more and more attention to the study of comprehensive utilization of the information devices of various fields to serve people better by adequately utilizing existing resource devices.

A browser may be software which may display content of Hyper Text Markup Language (HTML) files of a webpage server or a file system and allow a user to interact with these files. The browser may interact with the webpage server and obtain a webpage via the Hyper Text Transfer Protocol (HTTP). A webpage may correspond to a Uniform Resource Locator (URL), and a webpage may be found with the URL. A file format may be the HTML and may be recorded in the HTTP protocol by Multipurpose Internet Mail Extensions (MIME).

### SUMMARY

This section provides a general summary of the disclosure, and is not a comprehensive disclosure of its full scope or all of its features.

Various embodiments of the present disclosure may include an interaction method between browsers to enhance interaction efficiency of the browsers.

Various embodiments of the present disclosure may include an interaction device between browsers to enhance interaction efficiency of the browsers.

Various embodiments of the present disclosure may include a browser to enhance interaction efficiency of the browsers.

Various embodiments of the present disclosure may include the following.

An interaction method between browsers may include:

receiving a unique Identification (ID);

generating a Uniform Resource Locator (URL) with the unique ID;

obtaining webpage operation data of a webpage corresponding to the URL stored by a browser according to the unique ID; and

interacting with the browser with the webpage operation data.

An interaction device between browsers may include:

a unique ID receiving unit, to receive a unique ID and generate a Uniform Resource Locator (URL) with the unique ID;

an operation data obtaining unit, to obtain webpage operation data of a webpage corresponding to the URL stored by a browser according to the unique ID; and

an interaction operation unit, to interact with the browser with the webpage operation data.

A browser may include:

a request sending unit, to receive a first unique ID, generate a first URL with the first unique ID and send the first URL to a first browser;

a data storing unit, to access a second webpage corresponding to a second URL provided by the first browser, associate and store second webpage operation data of the second webpage and a second unique ID used for generating the second URL; and

an interaction unit, to obtain first webpage operation data of a first webpage corresponding to the first URL from the first browser according to the first unique ID and interact with the first browser with the first webpage operation data.

In view of the above technical scheme, according to various embodiments of the present disclosure, a unique ID may be received. The URL may be generated with the unique ID. The webpage operation data of the webpage corresponding to the URL stored by the browser may be obtained according to the unique ID. An interaction operation with the browser may be performed with the webpage operation data. According to various embodiments of the present disclosure, the interaction between the browsers may be implemented without installing the Flash plug-in in the browsers or requiring the browsers to support the HTML5 Socket technology, which may enhance interaction efficiency between the browsers.

Further areas of applicability will become apparent from the description provided herein. The description and examples in this summary are intended for purposes of illustration and are not intended to limit the scope of the present disclosure.

### DRAWINGS

The drawings described herein are for illustrative purposes of selected embodiments and not all possible implementations, and are not intended to limit the scope of the present disclosure.

FIG. 1 is a flow chart illustrating an interaction method according to various embodiments;

FIG. 2 is a diagram illustrating structure of an interaction device between browsers according to various embodiments;

FIG. 3 is a diagram illustrating an interaction system between browsers according to various embodiments;

FIG. 4 is a diagram illustrating structure of a browser according to various embodiments;

FIG. 5 is a diagram illustrating structure of another interactive device between browsers according to various embodiments; and

FIG. 6 is a diagram illustrating structure of another browser according to various embodiments.

Corresponding reference numerals indicate corresponding parts throughout the several views of the drawings.

### DETAILED DESCRIPTION

Example embodiments will now be described more fully with reference to the accompanying drawings.

According to various embodiments, browsers may interact with each other with a Socket mode. A real-time communication channel may be established between a browser of a mobile terminal device and a browser of a Personal Computer (PC) with the Socket mode, by which the interaction between different terminal devices may be implemented.

In order to utilize the Socket technology, the Socket technology should be supported by the browser of the mobile terminal device and the browser of the PC of the user and a Flash plug-in should be installed on the browser of the mobile terminal device and the browser of the PC of the user. As for a browser that cannot install the Flash plug-in and may not support the Socket technology, the interaction between browsers may not be implemented with the Socket technology. Therefore, an interaction technology threshold between the browsers may be enhanced with the Socket technology and interaction efficiency between the browsers may be reduced.

For simplicity and illustrative purposes, the present disclosure is described by referring mainly to various embodiments thereof. In the following description, numerous details are set forth in order to provide a thorough understanding of the present disclosure. It is apparent that the present disclosure may be practiced without limitation to these details. In other instances, some methods and structures have not been described in detail so as not to unnecessarily obscure the present disclosure. As used throughout the present disclosure, the term “includes” means includes but not limited to and the term “including” means including but not limited to. The term “based on” means based at least in part on. In addition, the terms “a” and “an” are intended to denote at least one of a particular element.

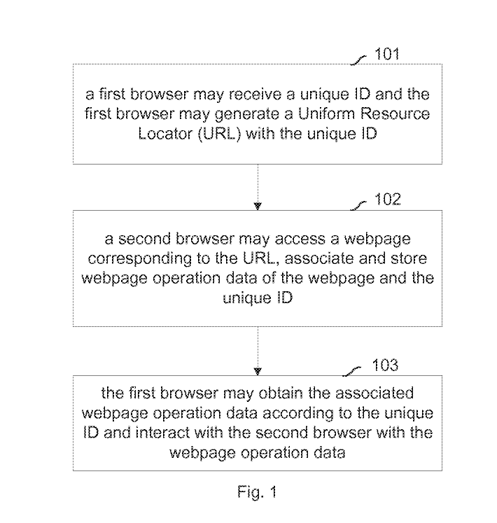

FIG. 1 is a flow chart illustrating an interaction method between browsers according to various embodiments of the present disclosure. In FIG. 1 the method may include the following.

Block 101: A first browser may receive a unique ID and the first browser may generate a Uniform Resource Locator (URL) with the unique ID. First, an initial display page may be opened by the first browser and the initial display page may send a unique ID generation request to a server in the background. The server may receive the unique ID generation request, generate the unique ID, and send the unique ID to the initial display page of the first browser. The initial display page may generate the URL with the unique ID.

When there are multiple browsers, multiple unique IDs may be generated and a corresponding relationship between browsers may be determined according to the unique IDs. The unique ID may be generated with multiple methods. For instance, the unique ID may be generated with pseudorandom number. The method for generating the unique ID may include but is not limited to the following methods. One method is a direct method. The unique ID may be generated according to the physical meaning of a distribution function. A second method may be an inversion method. It may be assumed that U may be evenly distributed in [0, 1]. X=F-1 (U) . A cumulative distribution function (CDF) of X may be F. This method is simple, accessible programming with wide applicability. A third method is an acceptance-rejection method. It may be assumed that the generation of a Probability Density Function (PDF) may be f. First, a random function generator and a constant c, in which the PDF may be g, may be found and f(x) cg(x). The f(x)≦cg(x) may then be solved with the acceptance-rejection method. Since a desired random number may be obtained with an average of c operations, the value of c should be as small as possible.

The examples for generating the unique ID are listed above. It may be well known by one with ordinary skill in the art that various embodiments of the present disclosure may not be limited to the above examples, which are merely provided for illustration.

According to various embodiments, a session ID or a Memcache ID may be generated. The Session may be user data stored in the server as a text file and searching may be made with the session ID. The Memcache may be a high-performance distributed memory object cache system and may be used for storing data of various formats, such as, image, video, file, and searching results of a database. The data may be written into the memory and read from the memory. Therefore, the reading speed of the data may be enhanced and the searching may be performed with the Memcache ID.

Block 102: A second browser may access a webpage corresponding to the URL and associate and store webpage operation data of the webpage and the unique ID. The second browser may access the webpage corresponding to the URL, store the webpage operation data of the webpage, associate the webpage operation data and the unique ID, and encapsulate and send the associated webpage operation data and the unique ID to the server. The webpage operation data of the webpage may include a webpage operation action command and a timestamp of the webpage operation action command.

The encapsulated data sent to the server may include:
(a) the webpage operation action command, i.e. operation actions of the user after the user browses the webpage with the second browser (in a format of agreed string);
(b) the unique ID which may be a session ID or an ID of a Memcache key value; and
(c) the timestamp which may be occurring time of the operation action. The unit of the occurring time may be ms or us.

Block 103: The first browser may obtain the associated webpage operation data according to the unique ID and interact with the second browser with the webpage operation data.

According to various embodiments, the first browser may search for the webpage operation data corresponding to the unique ID according to a preset reading time interval from the server. According to various embodiments, the server may push the webpage operation data corresponding to the unique ID to the first browser according to a preset pushing time interval.

The first browser may obtain the associated webpage operation data and perform the interaction operation with the webpage operation data. For instance, the first browser may perform the interaction operation, such as play a game or perform the activity, according to the webpage operation action command in the webpage operation data.

According to various embodiments, the method may further include generating, by the first browser a two-dimension image including the URL in block 101. The method for accessing the webpage corresponding to the URL with the second browser in block 102 may include detecting a two-dimension code in a two-dimension image to obtain a two-dimension outline, identifying the two-dimension code from which the detected two-dimension outline is detected, obtaining the URL in the two-dimension code, and accessing the webpage corresponding to the URL with the second browser.

The first browser may process the two-dimension image with various scanning applications. After the first browser scans the two-dimension code with the scanning applications, a camera video frame image may be obtained. The camera video frame image may be image data obtained from each frame of the video obtained by the camera. The scanning applications of the first browser may convert the camera video frame image into a gray image and convert the gray image into a binary image. Horizontal anchor feature scanning and vertical anchor feature scanning may be performed on the binary image to obtain a horizontal anchor feature line and a vertical anchor feature line. An intersection of the horizontal anchor feature line and the vertical anchor feature line may be computed to obtain an anchor position of the two-dimension code. The two-dimension code outline may be obtained according to the anchor position of the two-dimension code.

If a detection result shows that there is no two-dimension code in the camera video frame image, down-sample processing may be performed on the camera video frame image and the camera video frame image after the down-sample processing may be detected again to determine whether there is a two-dimension code.

According to various embodiments, the first browser may obtain all of the webpage history operation data according to the unique ID and obtain the newest webpage operation data from all of the webpage history operation data according to a timestamp. The method for performing the interaction operation with the webpage operation data may include performing the interaction operation with the newest webpage operation data.

According to various embodiments of the present disclosure, the data transferring of the interaction operation may be implemented with the session or Memcache technology. If the user opens the URL (via the two-dimension code) generated in the browser of the PC with the browser of the mobile terminal device (when there are multiple users, multiple mobile terminal device may participate in the operation), the interaction operation, such as the game and activity, may be performed.

In the reading and writing process of the session data or the Memcache data, the pressure of the server may be less than that of the database. Various embodiments of the present disclosure may also solve a compatibility issue in the process of the project development. Each interaction operation may be performed faster and more thoroughly in a rich media advertisement activity and an advertisement activity.

Various embodiments of the present disclosure may be described hereinafter taking the interaction between the mobile terminal device and the PC for example.

Currently, the smartphone and the mobile network are widely used. In some Internet activities, games, and advertisements, the interaction operation between the mobile terminal device and the PC may be implemented through various embodiments of the present disclosure. The browser may not be necessary to install the Flash plug-in or support the HTML5 Socket technology.

According to various embodiments, four interaction interfaces may be designed to implement the interaction between the browser of the mobile terminal device and the browser of the PC. The interaction interfaces may be a display page of the PC, a page for displaying transferring data content (the data may be read by the display page of the PC), the display page of the mobile terminal device, and a page for changing the transferring data content (receiving the data sent from the display page of the mobile terminal device).

The display page of the PC may be a foreground page of the PC. The display page of the mobile terminal device may be the foreground page of the mobile terminal device. The page for displaying the transferring data content and the page for changing the transferring data content may be background pages of the server.

If the user opens the display page of the PC with the browser of the PC, the server may generate one (or multiple) session ID or the ID of the Memcache key value and send the ID to the display page of the PC, so that the ID may be taken as the key for reading the data in the page for displaying the transferring data content. The ID may be the unique authentication value in the whole interaction process. The PC device may generate the URL with the ID.

The webpage corresponding to the URL may be accessed with the browser of the mobile terminal device and associate and store the webpage operation data of the webpage and the ID. The user may access the display page of the mobile terminal device in the mobile terminal device, obtain the unique key (i.e. the ID) of this interaction operation with parameters in the URL, and send the interaction data to the page for changing the transferring data content under the trigger of the user to change the content stored in the server.

The browser of the PC may obtain the associated webpage operation data according to the unique ID and perform the interaction operation with the webpage interaction data.

A front-end presentation program of the display page of the PC may be implemented with the flash technology or js technology, etc. The display page of the PC also may implement a cyclical execution function. That is, the interaction data may be cyclically read from the page for displaying the transferring data content according to preset reading time (such as 10 ms, which may be changed as needed). The interface data may be updated when the user accesses the display page of the mobile terminal device with the browser of the mobile terminal device. In a process where the display page of the PC reads the interaction data, whether the interaction data is up-to-date may be determined according to the ID and timestamp, by which logical determination of the program may be performed.

The interaction data content may include (a) an action which is an action (in the format of a string) performed by the user on the mobile terminal device; (b) the session ID or ID of the Memcache key value; and (c) a timestamp recording time of the action, the unit of which is ms or us. According to various embodiments of the present disclosure, the interaction operation between the mobile terminal device and the PC may be implemented with small delay.

On the basis of the above detailed analysis, various embodiments of the preset disclosure may further provide an interaction device between browsers.

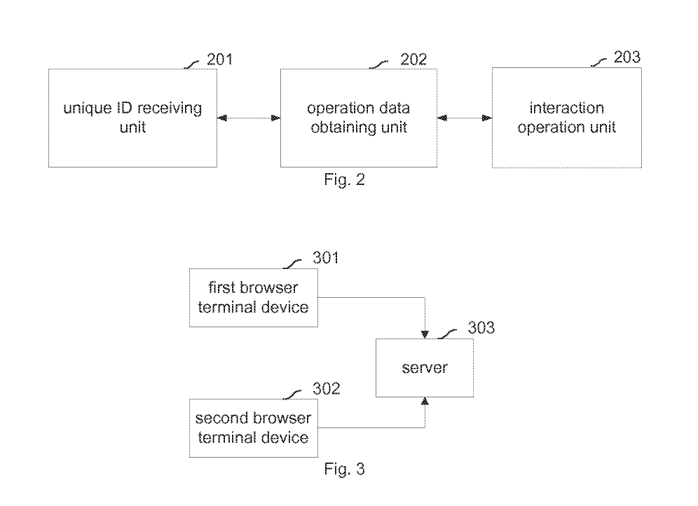

FIG. 2 is a diagram illustrating the structure of an interaction device between browsers according to various embodiments of the present disclosure. In FIG. 2, the interaction device may include a unique ID receiving unit 201, an operation data obtaining unit 202, and an interaction operation unit 203. The unique ID receiving unit 201 may receive a unique ID and generate a Uniform Resource Locator (URL) with the unique ID. The operation data obtaining unit 202 may obtain webpage operation data of a webpage corresponding to the URL stored by a browser according to the unique ID. The interaction operation unit 203 may interact with the browser through the webpage operation data. According to various embodiments, the unique ID receiving unit 201 may further generate a two-dimension code image including the URL.

The operation data obtaining unit 202 may further detect a two-dimension code in the two-dimension code image to obtain a two-dimension outline and identify the two-dimension code, from which the two-dimension outline may be obtained to obtain the URL in the two-dimension. According to various embodiments, the operation data obtaining unit 202 may further obtain a webpage operation action command and a timestamp of the webpage operation action command, associate and store the unique ID, the webpage operation action command, and the timestamp of the webpage operation action command. According to various embodiments of the present disclosure, the operation data obtaining unit 202 may further search for the webpage operation data corresponding to the unique ID according to a preset reading time interval or receive the pushed webpage operation data corresponding to the unique ID according to a preset pushing time interval.

On the basis of the above detailed analysis, various embodiments of the present disclosure may further provide an interaction system between browsers.

FIG. 3 is a diagram illustrating an interaction system between browsers according to various embodiments of the present disclosure.

As shown in FIG. 3, the system may include a first browser terminal device 301, a second browser terminal device 302, and a server 303. The server 303 may generate a unique ID and send the unique ID to the first browser terminal device 301. The first browser terminal device 301 may generate a URL with the unique ID. The second browser terminal device 302 may access a webpage corresponding to the URL and associate and store webpage operation data of the webpage and the unique ID in the server 303. The first browser terminal device 301 may further obtain the webpage operation data according to the unique ID from the server 303 and interact with the second browser terminal device 302 with the webpage operation data. According to various embodiments, the first browser terminal device 301 may further generate a two-dimension code image including the URL.

The second browser terminal device 302 may further detect a two-dimension code in the two-dimension code image to obtain a two-dimension outline, identify the two-dimension code, from which the two-dimension outline may be obtained to obtain the URL in the two-dimension code, and access the webpage corresponding to the URL with the second browser. According to various embodiments, the second browser terminal device 302 may further obtain a webpage operation action command and a timestamp of the webpage operation action command, associate and store the unique ID, the webpage operation action command, and the timestamp of the webpage operation action command.

According to various embodiments of the present disclosure, the first browser terminal device 301 may further search for the webpage operation data corresponding to the unique ID according to a preset reading time interval from the server 303 or to receive the webpage operation data corresponding to the unique ID from the server 303. The server 303 may push the webpage operation data according to a preset time interval. The first browser terminal device may be a PC including a browser. The second browser terminal device may be an intelligent terminal device including the browser. For instance, the intelligent terminal device may be a mobile phone, a smart phone, a handheld computer, a tablet PC, a Personal Digital Assistant (PDA), etc. The terminal devices may be described in detail in the above examples. It will be well known to one with ordinary skill in the art that the above examples may be listed for describing the present disclosure but not for limiting the protection scope of the various embodiments of the present disclosure.

On the basis of the above analysis, various embodiments of the present disclosure may further provide a browser.

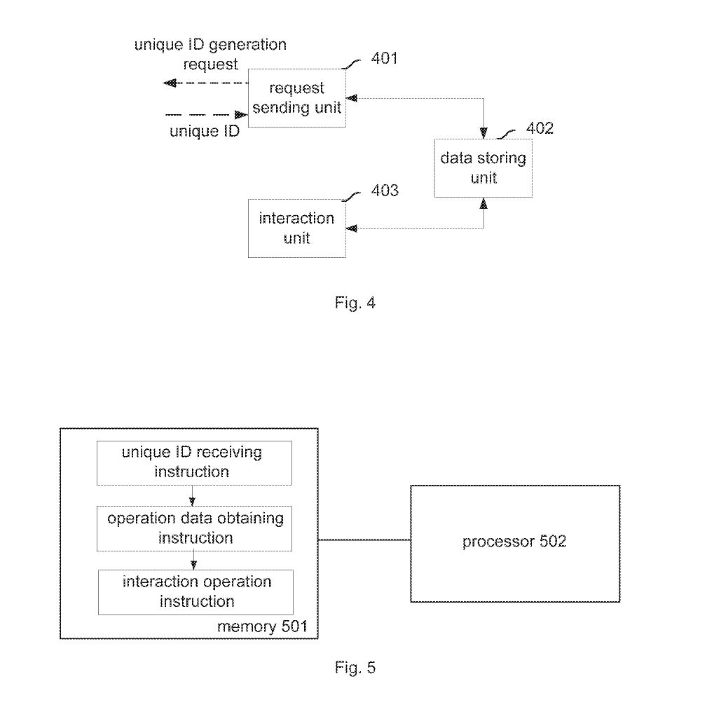

FIG. 4 is a diagram illustrating a browser according to various embodiments of the present disclosure. In FIG. 4, the browser may include a request sending unit 401, a data storing unit 402, and an interaction unit 403. The request sending unit 401 may receive a first unique ID, generate a first URL with the first unique ID, and send the first URL to a first browser. The data storing unit 402 may access a second webpage corresponding to a second URL provided by the first browser and associate and store second webpage operation data of the second webpage and a second unique ID used for generating the second URL. The interaction unit 403 may obtain first webpage operation data of a first webpage corresponding to the first URL from the first browser according to the first unique ID and interact with the first browser with the first webpage operation data. According to various embodiments, the interaction unit 403 may further search for the first webpage operation data corresponding to the first unique ID according to a preset reading time interval from the server or to receive the first webpage operation data corresponding to the first unique ID from the server. The server may push the first webpage operation data according to a preset pushing time interval.

FIG. 5 is a diagram illustrating the structure of another interactive device between browsers according to various embodiments of the present disclosure. The device may include a memory 501 and a processor 502. The memory 501 may store a unique ID receiving instruction, an operation data obtaining instruction, and an interaction operation instruction. The processor 502 may communicate with the memory 501 and execute the unique ID receiving instruction, operation data obtaining instruction, and interaction operation instruction to respectively execute operations of the above unique ID receiving unit 201, operation data obtaining unit 202, and interaction operation unit 203.

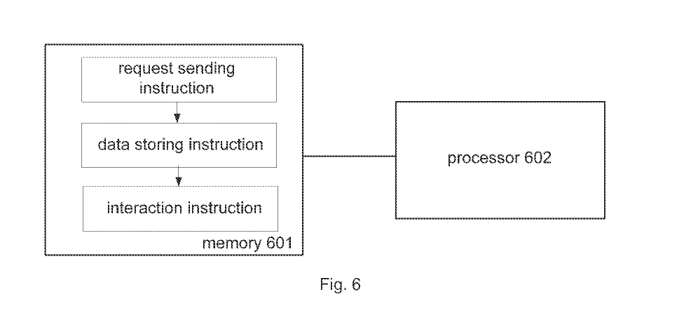

FIG. 6 is a diagram illustrating the structure of another browser according to various embodiments of the present disclosure. The browser may include a memory 601 and a processor 602. The memory 601 may store a request sending instruction, a data storing instruction, and an interaction instruction. The processor 602 may communicate with the memory 601 and execute the request sending instruction, data storing instruction, and interaction instruction to respectively execute operations of the above request sending unit 401, data storing unit 402, and interaction unit 403.

According to various embodiments of the present disclosure, the browsers may include Internet Explorer, Firefox of Mozilla, Safari of Apple, Opera, Google Chrome, and GreenBrowser. Some common browsers are described above. It will be known to one with ordinary skill in the art that various embodiments of the present disclosure are not limited to the above browsers and may be any App which may display the webpage server or a file in a file system and allow the user to interact with the file. The App may be each common browser and may be any application with a webpage browsing function.

The interaction method between browsers according to various embodiments of the present disclosure may be implemented through various modes. For instance, the interaction method between browsers may be programmed into a plug-in program installed in the browser according to a standard application program interface, or may be encapsulated into an application, so that users may download the application. If the interaction method between browsers is programmed into the program, the interaction method may be implemented with multiple plug-in formats, such as ocx, dll and cab. The interaction method between the browsers according to various embodiments of the present disclosure also may be implemented with a Flash plug-in, a RealPlayer plug-in, a Multimedia Message Service (MMS) plug-in, MI staff plug-in, an ActiveX plug-in, etc.

The interaction method between the browsers according to various embodiments of the present disclosure may be stored in various storage mediums in a format of instructions or an instruction aggregation. The storage mediums may include, but are not limited to, a floppy, a Compact Disc (CD), Digital Versatile Disc (DVD), hardware, a flash memory, a Universal Serial Bus (USB) flash disk, a Compact Flash (CF) card, a Secure Digital (SD) memory card, a Multimedia Card (MMC), a Smart Media (SM) card, a Memory Stick, an Extreme Digital (xD) picture card, etc.

Further, the interaction method between the browsers according to various embodiments of the present disclosure may be applied to a storage medium based on a Nand flash, such as the USB flash disk, the CF card, the SD memory card, the Secure Digital High Capacity (SDHC) card, the MMC card, the SM card, the Memory Stick, the xD picture card, etc.

In view of the foregoing, according to various embodiments of the present disclosure, a unique ID may be generated and the unique ID may be sent to the first browser. The first browser may generate the URL with the unique ID. The webpage corresponding to the URL may be accessed with the second browser. The webpage operation data of the webpage and the unique ID may be associated and stored. The first browser may obtain the associated webpage operation data according to the unique ID and execute the interaction operation with the webpage operation data. According to various embodiments of the present disclosure, the interaction between the browsers may be implemented without installing the Flash plug-in in the browser or requiring the browser to support the HTML5 Socket technology, which may enhance interaction efficiency between the browsers.

What has been described and illustrated herein are examples of the disclosure along with some variations. The terms, descriptions, and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more processes within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. An interaction method between browsers, comprising:
receiving a unique Identification (ID);
generating a Uniform Resource Locator (URL) with the unique ID;
obtaining webpage operation data of a webpage corresponding to the URL stored by a browser according to the unique ID; and
interacting with the browser with the webpage operation data.

2. The interaction method between browsers according to claim 1, wherein obtaining the webpage operation data of the webpage corresponding to the URL stored by the browser according to the unique ID comprises:
searching for the webpage operation data corresponding to the unique ID according to a preset reading time interval; or
receiving the pushed webpage operation data corresponding to the unique ID according to a preset pushing time interval.

3. The interaction method according to claim 1, wherein obtaining the webpage operation data of the webpage corresponding to the URL stored by the browser according to the unique ID comprises:
obtaining all history webpage operation data according to the unique ID and obtaining latest webpage operation data from all the history webpage operation data according to a timestamp;
interacting with the browser with the webpage operation data comprises:
interacting with the browser with the latest webpage operation data.

4. An interaction device between browsers, comprising:
a unique ID receiving unit, to receive a unique ID and generate a Uniform Resource Locator (URL) with the unique ID;
an operation data obtaining unit, to obtain webpage operation data of a webpage corresponding to the URL stored by a browser according to the unique ID; and
an interaction operation unit, to interact with the browser with the webpage operation data.

5. The interaction device between browsers according to claim 4, wherein
the operation data obtaining unit further searches for the webpage operation data corresponding to the unique ID according to a preset reading time interval, or receives the pushed webpage operation data corresponding to the unique ID according to a preset pushing time interval.

6. The interaction device between browsers according to claim 4, wherein
the operation data obtaining unit further obtains all history webpage operation data according to the unique ID and obtains the latest webpage operation data from all the history webpage operation data according to a timestamp; and
the interaction operation unit further interacts with the browser with the latest webpage operation data.

7. A browser, comprising:
a request sending unit, to receive a first unique ID, generate a first URL with the first unique ID and send the first URL to a first browser;
a data storing unit, to access a second webpage corresponding to a second URL provided by the first browser, associate and store second webpage operation data of the second webpage and a second unique ID used for generating the second URL; and
an interaction unit, to obtain first webpage operation data of a first webpage corresponding to the first URL from the first browser according to the first unique ID and interact with the first browser with the first webpage operation data.

8. The browser according to claim 7, wherein
the interaction unit further searches for the first webpage operation data corresponding to the first unique ID according to a preset reading time interval or receives the pushed first webpage operation data corresponding to the first unique ID according to a preset pushing time interval.

9. The interaction method between browsers according to claim 1, further comprising:
generating a two-dimension image including the URL, so that the browser accesses the webpage corresponding to the URL.

10. The interaction method between browsers according to claim 1, the unique ID is a session ID or an ID of a Memcache key value.

11. The interaction device between browsers according to claim 4, wherein the unique ID receiving unit is further to generate a two-dimension code image including the URL, so that the browser accesses the webpage corresponding to the URL.

12. The interaction device between browsers according to claim 4, the unique ID is a session ID or an ID of a Memcache key value.

13. The browser according to claim 7, wherein the data storing unit is further to detect a two-dimension code in a two-dimension code image to obtain a two-dimension outline, identify the two-dimension code, from which the two-dimension outline may be obtained to obtain the second URL in the two-dimension code and access the second webpage corresponding to the second URL.
